(19) United States
(12) Patent Application Publication
(10) Pub. No.: US 2008/0023863 A1
(43) Pub. Date: Jan. 31, 2008

(54) Method and apparatus for extrusion of profiled helical tubes

(75) Inventors: Lawrence Lee, Hardwicke (GB); Michael Shepherd, Stroud (GB)

Correspondence Address: SCHLUMBERGER OILFIELD SERVICES, 200 GILLINGHAM LANE, MD 200-9, SUGAR LAND, TX, 77478, US

(73) Assignee: Schlumberger Technology Corporation

(21) Appl. No.: 11/496,675

(22) Filed: Jul. 31, 2006

(51) Int. Cl. B29C 47/24; B29C 47/94

(52) U.S. Cl. 264/40.1; 264/209.2; 425/381; 425/381.2; 425/382.3; 425/466

(57) ABSTRACT

The present invention relates to a method of forming and an apparatus for forming a profiled helical tube (100, 200) by rotating a profile die (102, 202) during the extrusion process to impart a helical form to a profiled tube. A method of forming and an apparatus for forming a profiled helical tube (100, 200) can include a rotating or non-rotating profile die (202) with a helical extrusion gap (204). An extruded helical or non-helical tube 300 can be rotated by rotating the tube itself, for example, by rotating a haul-off mechanism (340, 340′).

### BACKGROUND OF THE INVENTION

The present invention relates generally to the extrusion of profiled helical tubes. More particularly, the present invention relates to forming a profiled helical tube by rotating a profile die during the extrusion process and/or by providing an extrusion die with a helical extrusion gap.

In many industries, there is a need for helical tubes with a non-circular cross-sectional profile. For example, a helical tube can form or be used to form a stator and/or rotor in a Moineau style motor or progressive cavity pump.

A continuous helical tube can be molded using a continuous set of clamshell molds. To withdraw a helical tube from a clamshell mold, the tubes formed are limited to those with substantially circular cross-sectional profiles that do not have recessed edges. If attempting to form a helical tube of a non-circular cross-sectional profile 100, for example, with the clamshell or two-piece rigid mold assembly (105A, 105B) of FIG. 1, the recessed edge of the tube, as shown by shaded area 107, undesirably retains the helical tube 100 within the mold as either portion (105A, 105B) of the mold is attempted to be removed from the helical tube 100. It is possible for a cross-sectional profile to be oriented in such a manner that there is no recessed edge 107 at that particular orientation. However, with the helix rotating three dimensionally along the axis of the tube 100, a recessed edge 107 will exist between the two-pieces (105A, 105B) of the rigid mold assembly along at least one portion of the entire helical tube 100.

A helical mold however can be used to manufacture a helical tube with a non-circular cross-sectional profile, but is limited to producing tubes of fixed length and typically requires a helical core to be removed after tube formation. To gain the flexibility of being able to produce tubes of various lengths, tubing can be produced by extrusion. Extrusion of materials, for example those that are flexible under temperature and/or pressure such as an elastomer, polymer, or metal, is well known in the art.

Extrusion has been utilized to create a coating over a continuous metallic core, as in electric cables, and plastic rods and tubes of various cross-sectional profiles. Although extremely complex cross-sectional shapes can be extruded, current implementations are limited to non-helical form.

U.S. Pat. Nos. 6,447,279, 6,669,458, and 6,692,804 to Guillemette et al., herein incorporated by reference, disclose a rotating extrusion die for wrapping multiple layers of extruded material over tubes. However the produced product is a non-helical tube with a substantially circular cross-sectional profile. None of the existing extrusion systems provide a method or apparatus that can produce the desired continuous length of a profiled helical tube.

### SUMMARY OF THE INVENTION

In one embodiment of the invention, a method of forming a profiled helical cylinder includes providing a source of an extrudable material, extruding the material through a profile die to form an extrudate, and rotating the profile die relative to the extrudate during the extruding step to form the profiled helical cylinder. The profile die can be a corrugated profile die. The profile die can be a hollow die. The profile die can form a non-hollow, profiled cylindrical extrudate.

In another embodiment of the invention, a method of forming a profiled helical tube includes providing a source of an extrudable material, extruding the material through a hollow die to form a profiled tube, and rotating the hollow die relative to the profiled tube during the extruding step to form the profiled helical tube.

In yet another embodiment of the invention, a method of forming a profiled helical tube includes providing a source of an extrudable material, extruding the material past at least one hollow die mandrel to form an extrudate with a profiled inner surface, extruding the extrudate through at least one hollow die cap to form a tube with a profiled outer surface, and providing relative rotation between the tube and an assembly including the at least one hollow die mandrel and the at least one hollow die cap during the extruding steps to form the profiled helical tube. The material can be extruded through the hollow die cap and then extruded past the hollow die mandrel, while an assembly of the die cap and die mandrel are rotated relative to the extruded tube to impart the helical form.

In another embodiment of the invention, a method of forming a profiled helical tube includes providing a source of an extrudable material and extruding the material through a hollow die having a helical mandrel and a die cap providing a helical land to form the profiled helical tube. The helical mandrel can form a profiled helical inner surface of the tube. The helical land can form a profiled helical outer surface of the tube.

In yet another embodiment of the invention, a method of forming a profiled helical tube includes providing a source of an extrudable material, and extruding the material through a helical extrusion gap of a hollow die to form the profiled helical tube.

In another embodiment of the invention, a method of forming a profiled helical tube includes providing a source of an extrudable material, providing a hollow die with at least one of a helical land and a helical mandrel, and extruding the material through the hollow die to form the profiled helical tube. The method can further comprise rotating the hollow die during the extruding step.

In yet another embodiment of the invention, an apparatus for forming a profiled helical tube includes a hollow die connected to an extrudable material source, and a rotational drive apparatus operatively connected to the hollow die to impart rotation thereto.

In another embodiment of the invention, an apparatus for forming a profiled helical tube includes a hollow die with a corrugated profile connected to an extrudable material source, and a rotational drive apparatus operatively connected to the hollow die to impart rotation thereto.

In yet another embodiment of the invention, an apparatus for forming a profiled helical tube includes a hollow die having at least one of a die cap providing a helical land and a helical mandrel, and an extrudable material source in communication with the hollow die. A distal end of the helical mandrel can extend through the helical land. A distal end of the helical mandrel can extend to at least a proximal end of the helical land.

In another embodiment of the invention, an apparatus for forming a profiled helical tube includes a hollow die providing a helical extrusion gap. The helical extrusion gap of the hollow die can be formed between a helical land of a die cap and an outer surface of a helical mandrel extending therethrough. The distal ends of the helical mandrel and the helical land can be coterminous or non-coterminous. The extension of the distal end of the helical land beyond the end of the distal end of the helical mandrel allows the land to guide and support the curing extrudate.

In yet another embodiment of the invention, an apparatus for forming a profiled helical tube further includes a rotational drive apparatus to rotate the hollow die and/or to rotate the extrudate, profiled tube, or profiled helical tube. A rotational drive apparatus can be operatively connected to the hollow die and/or profiled helical tube to impart rotation thereto.

In another embodiment, an apparatus for forming a profiled helical tube includes a hollow die in communication with an extrudable material source to extrude a profiled tube, and a rotational drive apparatus in cooperative rotatable alignment with the hollow die imparting a helical form to the profiled tube.

### BRIEF DESCRIPTION OF THE DRAWINGS

The appended drawings illustrate typical embodiments of this invention and therefore should not be considered limiting in scope.

FIG. 1 is a cross-sectional view of a two-piece clamshell mold assembly of the prior art.

FIG. 2 is an exploded schematic view of a profile die with a linear extrusion gap, according to one embodiment of the invention.

FIG. 3 is a perspective view of the assembled rotating profile die of FIG. 2 forming a profiled helical tube by extrusion.

FIG. 4 is a cross-sectional view of the extruded profiled helical tube formed by the profile die of FIGS. 2-3.

FIG. 5 is a cross-sectional view along a longitudinal axis of the profile die with a linear extrusion gap of FIGS. 2-3.

FIG. 6 is an exploded schematic view of a profile die with a helical extrusion gap, according to one embodiment of the invention.

FIG. 7 is a perspective view of the assembled profile die of FIG. 6 forming a profiled helical tube by extrusion.

FIG. 8 is a cross-sectional view along a longitudinal axis of the profile die with a helical extrusion gap of FIGS. 6-7.

FIG. 9 is a cross-sectional view along a longitudinal axis of a profile die with a helical extrusion gap and an extended helical mandrel, according to one embodiment of the invention.

FIG. 10 is a perspective view of the extended helical mandrel of FIG. 9.

FIG. 11 is a perspective view of the profile die with a helical extrusion gap and the extended helical mandrel of FIGS. 9-10.

FIG. 12 is a perspective view of the profile die with the helical extrusion gap and the extended helical mandrel of FIG. 11 with a section of profiled helical tube formed by extrusion.

FIG. 13 is a cross-sectional view along a longitudinal axis of a profile die with a helical extrusion gap and an extended helical land, according to one embodiment of the invention.

FIG. 14A is a perspective view of a wheeled haul-off mechanism providing rotation to an extruded tube formed by a profile die, according to one embodiment of the invention.

FIG. 14B is a perspective view of the radial exterior surface of one wheel of the haul-off mechanism of FIG. 14A.

FIG. 15 is a perspective view of a belted haul-off mechanism providing rotation to an extruded tube formed by a profile die, according to one embodiment of the invention.

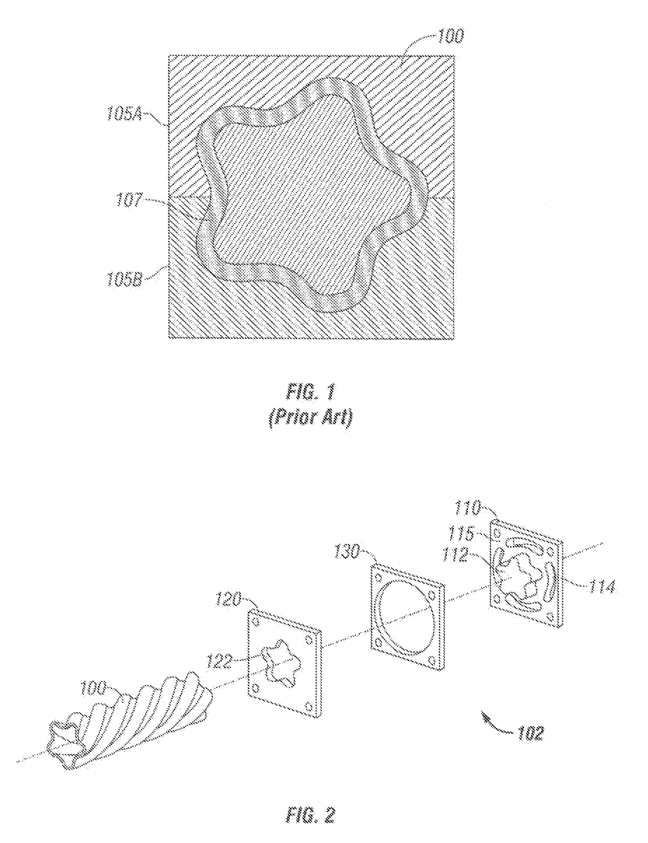

### DETAILED DESCRIPTION OF THE INVENTION

The present invention provides an apparatus for and method of forming a profiled helical tube by rotating a profile die during the extrusion process and/or providing a profile die with a helical extrusion gap.

As used herein, the term helical shall refer to a three-dimensional curve that lies on a cylinder or cone. As used herein, the term extrusion shall refer to the act or process of shaping material by forcing it through at least one die or aperture.

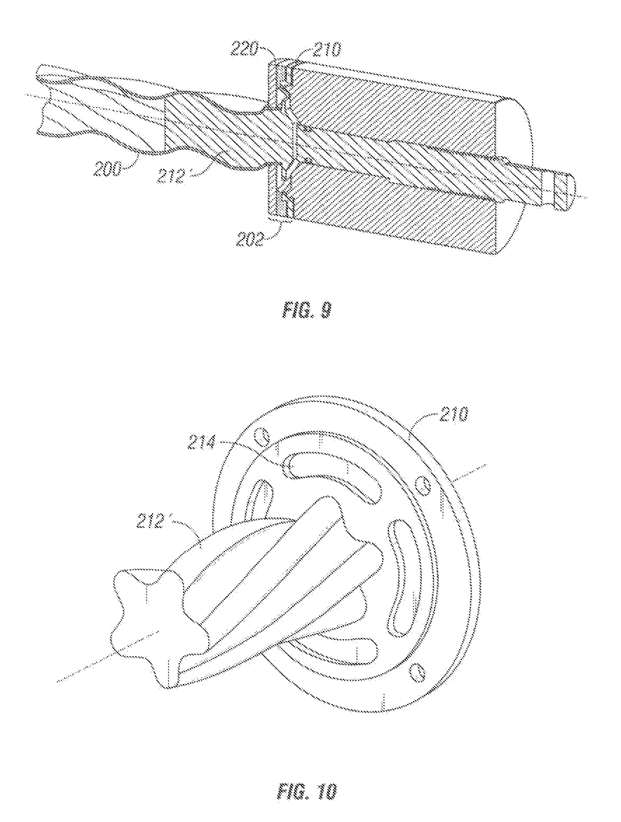

FIG. 2 is an exploded schematic view of a profile die 102 for forming a profiled helical tube 100 by extrusion. As used herein, the term profile die shall refer to a die of appropriate configuration for shaping material extruded therethrough. The profile can be a corrugated profile as shown, however any cross-sectional shape can be formed, as is known in the art. The material or materials used for extrusion can include a polymer, an elastomer, metal, or any other extrudable substance. The extrusion process can be at any temperature and/or pressure. The power for the extrusion can include, but is not limited to, a mechanical or hydraulic press, for example, the screw press of FIG. 9. The source of power can be any means known in the art and can include multiple sources. The extrudable material can be provided to the means for extrusion by any means known in the art. Although a length of extruded profiled helical tube 100 is shown, the invention can extrude a continuous length of profiled helical tube.

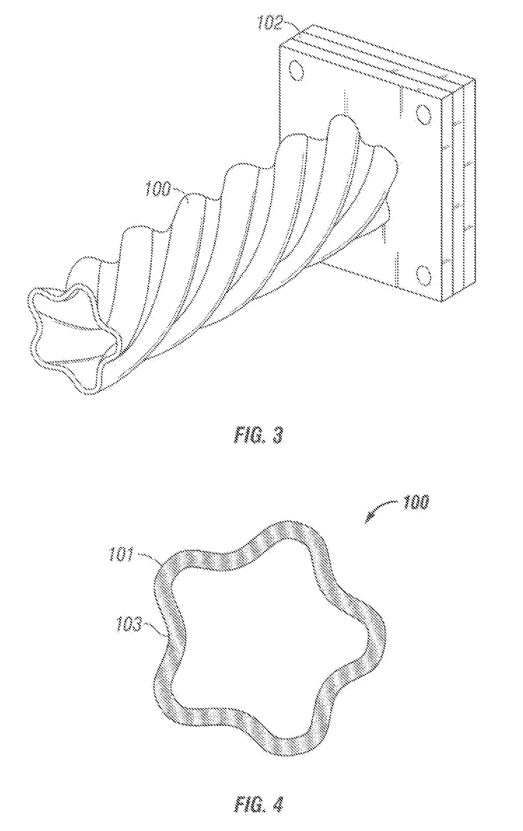

In the embodiment shown in FIGS. 2 through 5, the profile die 102 is a hollow die, shown in an exploded schematic view in FIG. 2. A hollow die 102, as used herein, is one that forms extruded closed profiles containing one or more voids, for example tubing with a rectangular cross-section. A hollow die 102 generally consists of a die cap 120 (or die proper) which generates the profile of the outer surface and the mandrel 112 (or core) which generates the inside contour. Hollow or semi-hollow profiles are typically produced with either bridge, porthole, or spider (taper seal) type of hollow dies or variants thereof. In FIG. 2, the mandrel 112 extends from an interior geometry plate 110, but a separate plate configuration is not required to utilize the mandrel 112. For example, the hollow die 102 can be a spider die (not shown) where multiple legs attach the mandrel 112 directly to the die cap 120. The extrudable material flows between the legs of the spider die and reunites before emerging through the die cap 120. FIG. 3 illustrates a hollow die 102 formed by an interior geometry plate 110, spacer 130, and die cap 120 assembly. The elements can be connected by any means known in the art.

Although the hollow die 102 forms an extruded profiled tube 100 with a five lobed 101 (in FIG. 4) cross-sectional profile, the invention is not so limited. A profile die 102 can create substantially any desired profile or shape. In a preferred embodiment, a profiled tube can be any plurality of lobes 101 and/or corrugated cross-sectional profile.

In use, a source of an extrudable material (not shown) is provided to the hollow die 102 through any means known in the art. In the embodiment shown, the material is extruded through at least one aperture 114 in the interior geometry plate 110 and past mandrel 112 to form a profiled inner surface. The spacer 130, if used, aids in containing the extrudable material and can provide an area where the material can reunite after being severed by the slits 115 in the interior geometry plate 110. The material is further extruded through the land 122 (also referred to as a die aperture or bearing) in the die cap 120 to create a profiled outer surface. The extruded tube 100, and correspondingly the extrusion gap 104, in this embodiment has a five lobed corrugated cross-sectional profile as seen in FIG. 4. One embodiment can have 2, 3, 4, 6, 7, 8, 9, 10, 11, 12, 15, 20, 50, 100, or a range of lobes where the lower and upper limits of the range are selected from the number of lobes specified here.

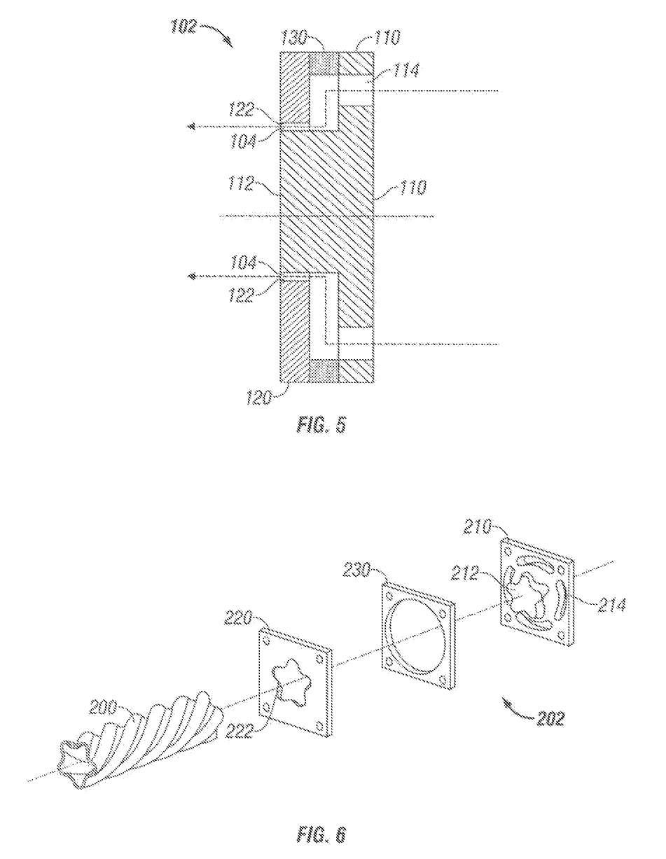

FIG. 5 illustrates the extrusion gap 104 or pathway formed between the mandrel 112 and the land 122 (or die aperture) in the die cap 120. If a spider type die is utilized (not shown), the extrusion gap 104 can be formed without use of a spacer 130 or an inner geometry plate 110 as the mandrel 112 is supported in the land 122. The extrusion gap 104 in the illustrated embodiment has a geometry that is substantially parallel to the flow path of the material. Such a linear geometry of the extrusion gap 104, with respect to the direction of material flow, creates a non-helical multiple lobed tube (not shown) with lobes 101 that are parallel to the longitudinal bore of the tube.

The current invention forms a helical tube 100 by imparting relative rotation between the tube 100 and the hollow die 102. To impart relative rotation, the hollow die 102 and/or the tube 100 itself can be rotated by any means known in the art, which can include a rotational drive apparatus. Although the extrusion gap 104 is shown as a constant width, it can be varied by design of the mandrel 112 and/or land 122 to create a profiled tube 100 with varying thickness. For example the valley 103 between each lobe 101 of the extrusion gap 104 can be thicker than the apex of each lobe. Each lobe 101 can have a different thickness at its apex. The mandrel 112 and land 122 can also be designed for use with any material. For example the depth of the land 122 and/or length of the mandrel 112 can be design adjusted depending on the particular material used. The mandrel 112 can extend beyond the land 122. Die 102 design can be by any means known in the art, and can take into consideration multiple design parameters, for example die swell.

In use, the hollow die 102 is utilized in a typical manner of the art, however as the material is extruded from the linear extrusion gap 104, the hollow die 102 is rotated relative to the extrudate 100 during the extruding step (as shown in FIG. 3), by any means known in the art, to impart a helical pattern to the extrudate. The rotation can be substantially around a longitudinal axis of the hollow die 102 and can be clockwise or counterclockwise. The extruded tube 100 can be rotated, as further described in reference to FIGS. 14A-15, without departing from the spirit of the invention. Both extruded tube 100 and hollow die 102 can be rotated to produce relative rotation therebetween. The extrusion rate, relative rotation rate, and/or direction of rotation can control the pitch of the extruded profiled helical tube 100. In a preferred embodiment, the rate of relative rotation is proportional to the material feed rate to generate the desired pitch for the helix. In the embodiment shown, an extruded profiled helical tube 100 with a non-circular cross-sectional profile (FIG. 4) is formed. Although the section of extruded profiled helical tube 100 is shown with a constant pitch, the pitch can vary in a section of tube and still be considered helically shaped. A preferred embodiment has a relatively long pitch length (the axial distance of one 360-degree helical turn of one lobe), for example, a pitch length between two to twenty times that of the major diameter. However, the apparatus and methods disclosed can be used to extrude a profiled helical tube of any pitch length. A desired length of extruded profiled helical tube 100 can be cut or otherwise formed from the continuous length extruded profiled helical tube 100 by any means known in the art.

FIGS. 6 through 8 illustrate an embodiment of the invention with a non-linear, helical extrusion gap 204. As discussed above in reference to the linear extrusion gap embodiment of FIGS. 2-5, any type of profile die can be used. In this embodiment the profile die incorporates a helical extrusion gap 204. A hollow type of profile die 202 is used for illustrative purposes. Similarly, the hollow die 202 is not limited to the form illustrated in the figures, as multiple plates are not required to form a hollow die 202. A die can be of any design known in the art and is not limited to a die formed by plates or a hollow die.

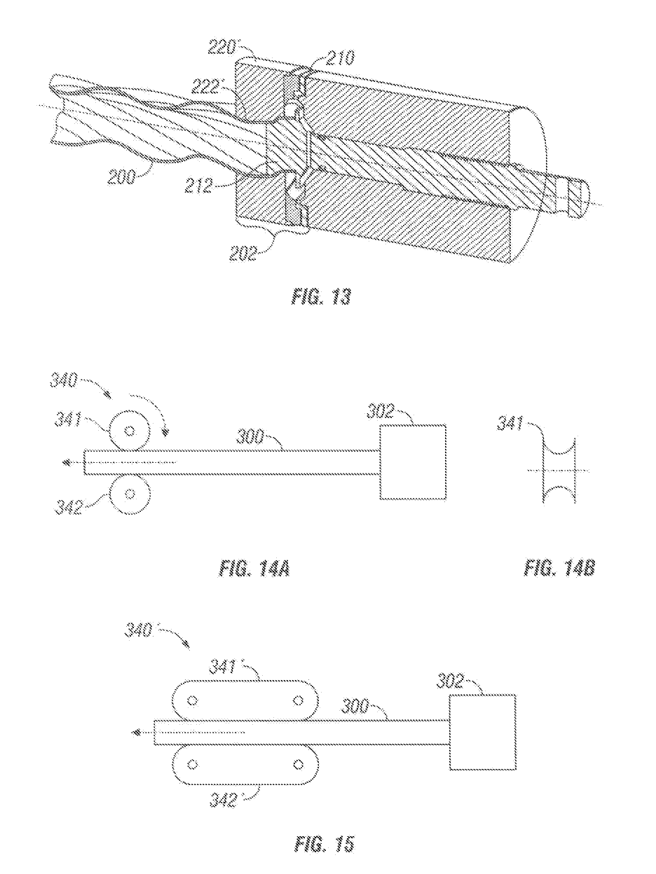

FIG. 6 shows an exploded schematic view of one embodiment of a hollow die 202 used to form the extruded profiled helical tube 200. In the illustrated embodiment, an interior geometry plate 210 contains apertures 214 to allow the material to enter the hollow die 202. The material can then be reunited in the chamber formed at least partially by the spacer 230, while an inner surface of the extruded material contacts, and thus takes the form of, the helical mandrel 212. The extrudate with a profiled inner surface can then flow through the helical land 222 in the die cap 220 and exit the hollow die 202 with a profiled outer surface. Although the distal ends of the helical land 222 and the helical mandrel 212 are coterminous in FIG. 8, the distal ends can be non-conterminous, for example, as shown in FIG. 9 and FIG. 13.

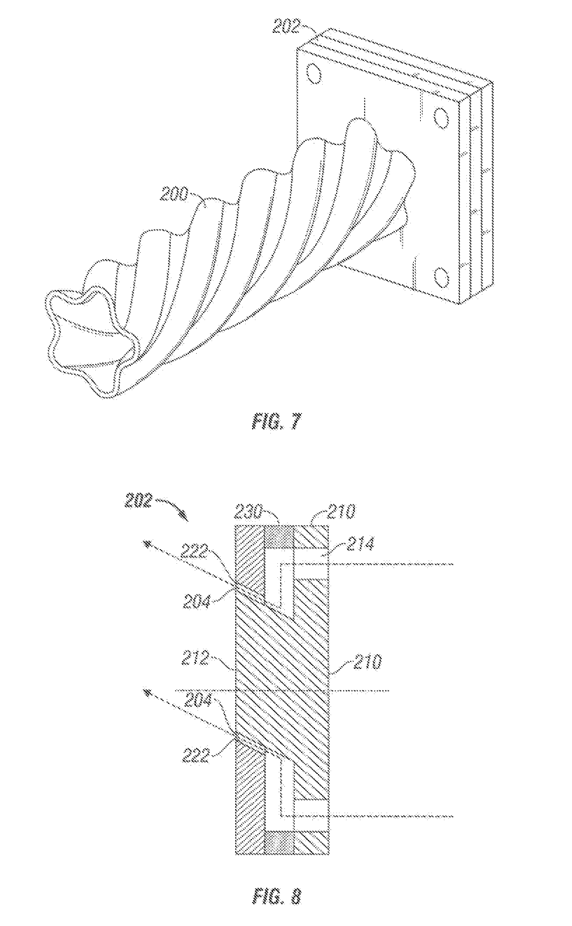

To form the helical extrusion gap 204, a distal end of the helical mandrel 212, in regards to the material flow, can extend to at least a proximal end of the helical land 222. As assembled in FIGS. 7-8, the adjacent exterior surface of the mandrel 212 and the inner surface of the die cap 220, referred to as the land 222, can be designed to create a helical extrusion gap 204 of desired shape and thickness. FIG. 8 illustrates the non-linear, helical extrusion gap 204 that can be formed between the helical mandrel 212 and the helical land 222 (or die aperture) in the die cap 220. The pitch and/or geometry of the helical extrusion gap 204 are not necessarily the same pitch and/or geometry as the extruded profiled helical tube produced 200. The pitch of the helical extrusion gap 204, extrusion rate, and/or type of material extruded can determine the pitch and/or geometry of the extruded profiled helical tube 200.

In use, the material is extruded through the helical extrusion gap 204 of the hollow die 202 and is expelled at an angle as shown in FIG. 8. With a tubular cross-sectional profile, this results in a twisting of the extrudate and a helical pattern being formed in the extruded profiled tube 200 as shown in FIG. 7. The helical extrusion gap 204 can form a clockwise or counter-clockwise helix.

A helical extrusion gap 204 can be formed between any combination of linear or helical lands 222 and linear or helical mandrels 214. For example, a helical mandrel with a corrugated cross-sectional profile 212 and a land with a circular cross-sectional profile (not shown) can be utilized to create an extruded profiled helical tube with a corrugated inner surface and substantially circular outer surface.

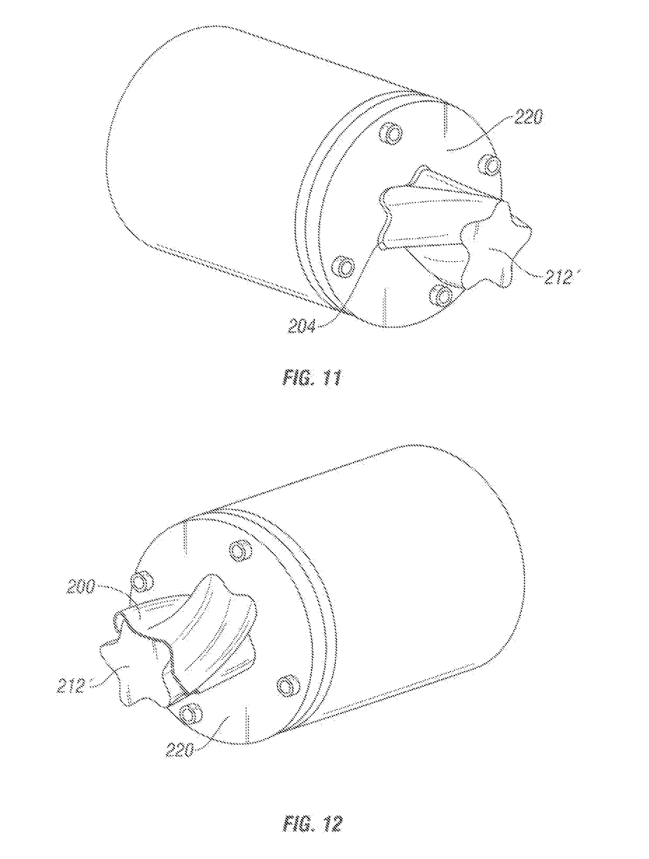

Referring now to FIGS. 9 through 12, an embodiment of a hollow die 202 with an extended mandrel 212′ is illustrated. FIG. 9 illustrates the extruded profiled helical tube 200 extending beyond the extended mandrel 212′ during the extrusion process. FIG. 10 illustrates the extended mandrel 212′ of the interior geometry plate 210 used in the current embodiment, with apertures 214 for allowing material to flow into the hollow die 202. FIG. 11 illustrates the helical extrusion gap 204 before material is extruded therefrom. FIG. 12 illustrates the embodiment of FIG. 11 as material is being extruded from the helical extrusion gap 204 to form the extruded profiled helical tube 200. The extended mandrel 212′ can further guide and/or form the extruded profiled helical tube 200. With material that can take additional time to sufficiently cure, the extended mandrel 212′ can guide and/or support the extruded profiled helical tube 200 until it has cooled and/or cured to a sufficient state, for example to retain its shape. The curing time can depend on the material being extruded and/or the thickness of the uncured material extruded from the helical extrusion gap 204. The concept of the extended length mandrel 212′ can be applied to any embodiment without departing from the spirit of the invention.

Similarly, a rotational drive apparatus (not shown) can be utilized with any embodiment of the invention to rotate the hollow die 202 and/or the profiled helical tube 200 during or after extrusion. A rotatable die and/or tube can aid in the forming of the helix and/or allow pitch adjustment.

Although a single hollow die has been used to describe the invention, it is not so limited. Multiple dies can be utilized. Any die used in the invention can include multiple mandrels (212, 212′) and/or die caps (220, 220′) with a land (222, 222′), with each set of mandrel 212 and land 222 gradually forming a progressively tighter extrusion gap 204, for example. Alternatively, multiple lands 222 can be utilized, with each successively smaller land 222 gradually forming a tighter extrusion gap 104 with the mandrel 212.

FIG. 13 is a cross-sectional view along a longitudinal axis of a hollow type of profile die 202 with a helical extrusion gap and an extended helical land 222′ formed in the die cap 220′. As with the extended helical mandrel 212′ embodiment of FIGS. 9-12, an extended helical land 222′ can further guide and/or form the extruded profiled helical tube 200. With material that can take additional time to sufficiently cure, the extended land 222′ can guide and/or support the extruded profiled helical tube 200 until it has cooled and/or cured to a sufficient state, for example to retain its shape.

FIGS. 14A-15 illustrate the use of an optional haul-off mechanism (340, 340′). A haul-off mechanism (340, 340′) can include a plurality of free spinning or powered wheels (341, 342), belts (341′, 342′), or cylinders to pull or to assist movement of the extruded tube 300. The haul-off mechanism (340, 340′) can be resiliently held into contact with the extruded tube 300, for example, by a spring. A haul-off mechanism (340, 340′) can remain axially stationary while allowing rotation about said axis. A haul-off mechanism (340, 340′) can be in cooperative rotatable alignment with the hollow die 302, for example, substantially coaxial.

As discussed above, in use an extrudable material is forced through a hollow die 302, which can have a linear extrusion gap or a non-linear, helical extrusion gap, to produce an extrudate 300, shown as an extruded tube. As the extruded tube 300 is expulsed from the hollow die 302, the typically uncured and pliable extruded tube 300 can be displaced from adjacent the hollow die 302 by a haul-off mechanism 340, as is known to those of ordinary skill in the art. FIG. 14A is a schematic drawing of one embodiment of a haul-off mechanism 340, utilizing a pair of opposing wheels (341, 342). Either or both wheels (341, 342) can be rotationally driven to displace the extruded tube 300. FIG. 14B is a perspective view of the wheel 341 having a radial incurvate exterior surface corresponding to the profile of the extruded tube 300.

FIG. 15 is a second embodiment of a haul-off mechanism 340′ consisting of two opposing belts (341′, 342′). Either or both belts (341′, 342′) can be rotationally driven to thereby displace the extruded tube 300. Although opposing pairs of wheels (341, 342) and belts (341′, 342′) are shown, the invention is no so limited. Any number or orientation of wheels, cylinders, or belts can be used to provide support and/or displace the extrudate. A haul-off mechanism can include a complex system of tilting belts for size monitoring and control, for example. Although depicted as wheels and belts in FIGS. 14A-15 respectively, any type of haul-off mechanism can be utilized without departing from the spirit of the invention.

Relative rotation about the longitudinal axis of an extruded tube 300 can be desirable, for example, to allow imparting a helical form to the tube. The present invention allows relative rotation between the hollow die 302 and the extruded tube 300, preferably when the extruded tube is pliable, to optionally impart a helical shape to said extruded tube. Relative rotation between a hollow die 302 having a linear extrusion gap and an extruded non-helical profiled tube can impart a helical form in the non-helical profiled tube. Relative rotation can be achieved by rotating the hollow die 302, rotating the extruded tube 300, or a combination thereof. Rotation of the extruded tube 300 can be achieved by rotating the haul-off mechanism (340, 340′), as shown schematically in FIGS. 14A and 15, with a rotational drive apparatus. Rotation is not required to be concomitant with the extrusion step, and can be imparted to a pliable profiled tube after and separate from said extrusion step.

Although the relative rotation between a hollow die with a linear extrusion gap (See FIG. 5) and an extruded tube imparts the helical pattern, relative rotation can be imparted between an extruded tube and a hollow die with a helical extrusion gap (See FIG. 8). For example, relative rotation can be added during extrusion to adjust or vary the pitch of the produced profiled helical tube from the pitch of the profiled helical extrusion gap. Further, rotation of he extruded tube 300 and rotation of a hollow die 302 can both be imparted. The extruded tube 300 and the hollow die 302 can be rotated at differing rotational speeds to create relative rotation therebetween. The profile die 302 and the extruded tube 300 can rotate in the same or in opposing directions, if so desired, to produce relative rotation. The rate of relative rotation can be design selected to produce a desired pitch of produced profiled helical tube. The rate of relative rotation can be varied during the extrusion process, for example, to impart the desired pitch to the profiled helical tube. For example, a lower rate of relative rotation can be desirable at lower rate of extrusion. The extrusion rate, relative rotation rate, and/or direction of rotation can control the pitch of the extruded profiled helical tube.

Extruding material through a hollow die with a helical extrusion gap (See FIG. 8) will generate a profiled helical tube without relative rotation added. However, as the extruded profiled helical tube is discharged from the helical extrusion gap, said tube will rotate relative to the hollow die due to the helical form. Rotation can optionally be imparted to said extruded tube, for example, with at least one haul-off mechanism, at the same rate and direction of rotation as the pitch of the helical extrusion gap of the hollow die. Such a configuration can provide support for a pliable extruded tube to retain the as-extruded pitch until sufficiently cured.

Numerous embodiments and alternatives thereof have been disclosed. While the above disclosure includes the best mode belief in carrying out the invention as contemplated by the named inventors, not all possible alternatives have been disclosed. For that reason, the scope and limitation of the present invention is not to be restricted to the above disclosure, but is instead to be defined and construed by the appended claims.

What is claimed is:

1. A method of forming a profiled helical cylinder comprising:
providing a source of an extrudable material;
extruding the material through a profile die to form an extrudate; and
providing relative rotation between the extrudate and the profile die during the extruding step to form the profiled helical cylinder.

2. The method of claim 1 wherein the profile die is a corrugated profile die.

3. The method of claim 1 wherein the profile die is a hollow die and the extrudate is a profiled tube.

4. The method of claim 3 wherein the step of extruding the material through the hollow die to form the profiled tube comprises:
extruding the material past at least one hollow die mandrel to form an extrudate with a profiled inner surface; and
extruding the extrudate through at least one hollow die cap to form the tube with a profiled outer surface.

5. The method of claim 3 wherein the step of extruding the material through the hollow die to form the profiled tube comprises:
extruding the material through at least one hollow die cap to form an extrudate with a profiled outer surface; and
extruding the extrudate past at least one hollow die mandrel to form the tube with a profiled inner surface.

6. A method of forming a profiled helical tube comprising:
providing a source of an extrudable material; and
extruding the material through a helical extrusion gap of a hollow die to form the profiled helical tube.

7. The method of claim 6 wherein the helical extrusion gap of the hollow die is formed between a helical mandrel and a die cap providing a helical land.

8. The method of claim 7 wherein the helical mandrel forms a profiled helical inner surface of the profiled helical tube.

9. The method of claim 7 wherein the helical land forms a profiled helical outer surface of the profiled helical tube.

10. The method of claim 6 wherein the hollow die has at least one of a helical land and a helical mandrel.

11. The method of claim 6 further comprising providing relative rotation between the profiled helical tube and the hollow die during the extruding step.

12. The method of claim 11 wherein the step of providing relative rotation occurs when the material is pliable.

13. An apparatus for forming a profiled helical tube comprising:
a hollow die in communication with an extrudable material source; and
a rotational drive apparatus operatively connected to the hollow die to impart rotation thereto.

14. The apparatus of claim 13 wherein the hollow die has a corrugated profile.

15. The apparatus of claim 13 wherein the hollow die has at least one of a die cap providing a helical land and a helical mandrel.

16. The apparatus of claim 15 wherein a distal end of the helical mandrel extends through the helical land.

17. The apparatus of claim 15 wherein a distal end of the helical mandrel extends to at least a proximal end of the helical land.

18. An apparatus for forming a profiled helical tube comprising:
a hollow die in communication with an extrudable material source to extrude a profiled tube; and
a rotational drive apparatus in cooperative rotatable alignment with the hollow die rotating the extruded profiled tube to impart a helical form to said tube.

19. An apparatus for forming a profiled helical tube comprising:
a hollow die providing a helical extrusion gap to extrude the profiled helical tube.

20. The apparatus of claim 19 wherein the helical extrusion gap of the hollow die is formed between a helical land of a die cap and an outer surface of a helical mandrel extending therethrough.

21. The apparatus of claim 20 wherein a distal end of the helical land and a distal end of the helical mandrel are coterminous.

22. The apparatus of claim 20 wherein a distal end of the helical land and a distal end of the helical mandrel are non-coterminous.

23. The apparatus of claim 19 further comprising a rotational drive apparatus operatively connected to the hollow die to impart rotation thereto.

24. The apparatus of claim 19 further comprising a rotational drive apparatus operatively connected to the profiled helical tube to impart rotation thereto.
